(19) United States
(12) Patent Application Publication
(10) Pub. No.: US 2023/0390796 A1
(43) Pub. Date: Dec. 7, 2023

(54) TOUCHLESS DISPENSER

(71) Applicant: MEIYUME HOLDINGS (BVI) LIMITED, Road Town, Tortola (VG)

(72) Inventor: Bernard WONG, Kowloon, Hong Kong (CN)

(21) Appl. No.: 18/249,377

(22) PCT Filed: Oct. 19, 2020
(86) PCT No.: PCT/CN2020/121749

§ 371 Date: Apr. 17, 2023

(51) Int. Cl. B05B 12/12; A47K 5/12; B05B 11/10

(52) U.S. Cl. CPC B05B 12/122; A47K 5/1205; A47K 5/1217; B05B 11/1052

(57) ABSTRACT

The present disclosure is directed to touchless dispensers that include features that are adjustable or selectable to receive various sized and shaped dispensers. For example, the dispensers may include a container and a dispense portion (e.g., a spray mechanism, a pump mechanism, or some other dispense mechanism). The touchless dispensers include a controller in electrical communication with a sensor and an actuator. When the sensor detects an object, the sensor sends a signal to the controller, and the controller interprets and reviews the signal from the sensor. If the controller determines an object is present, the controller sends a signal to the actuator, and the actuator moves in response to push against the dispenser. The actuator pushing against the dispenser causes the dispense portion to be depressed and to be dispense or expelled out of the touchless dispenser.

### BACKGROUND

### Technical Field

The present disclosure is directed to a dispenser that dispenses a liquid, a semi-liquid, or other viscous material.

### Description of the Related Art

Generally, conventional dispensers such as fragrance (e.g., perfume, cologne, etc.) dispensers, cosmetics dispensers, sanitizing (e.g., soap, sanitizer, etc.) dispensers, lotion dispensers, or some other substance dispenser include a pump mechanism or a spray mechanism. The substance in the conventional dispenser is accessible by a user through applying a force to the pump mechanism or the spray mechanism. The applied force may be a downward pushing force applied by a hand of the user onto the pump mechanism or the spray mechanism to dispense or expel the substance from the dispenser.

While the user can access the substance in the dispenser by pushing down with the force on the pump mechanism or the spray mechanism with their hand, if the dispenser is a test sample provided in a department store, a clothing store, a mall, or some other place to be utilized by multiple users, the use by multiple users is not hygienic and increases the transferring of germs, disease, viruses, or pathogens through multiple users touching the pump mechanism or the spray mechanism of the conventional dispenser.

Generally, conventional dispensers include an internal container such as a bag, a casing, or some other type of container that is refilled when the dispenser is empty. Refilling the internal container is messy and can result in spills. For example, when an internal bag of a sanitizer dispenser is empty, an individual must refill the internal bag by pouring a sanitizer from a large container into the bag, which is then placed within the sanitizing dispenser. During this process, the individual may accidentally spill large amounts of sanitizer if the individuals grip on the large container slips.

Generally, a conventional dispenser can only receive the internal container specifically designed for the conventional dispenser. For example, as discussed directly above, a conventional sanitizer dispenser is configured to only receive the internal bag as discussed above.

### BRIEF SUMMARY

Embodiments of the present disclosure address one or more of the drawbacks associated with conventional dispensers. Some embodiments in accordance with the present disclosure are able to provide a more hygienic experience for a user or a customer accessing a test sample within a department store, a clothing store, a mall, or some other place. Some embodiments of the present disclosure are able to receive any number of variously sized dispensers in which a number substances are shipped and sold in without having to remove the substance from the dispenser, which provides a universal touchless dispenser that can contain any number of differently shaped or sized dispensers.

The present disclosure is directed to various embodiments of a device that includes a base having a first surface and a second surface opposite to the first surface. A press plate is at the first surface of the base and an actuator mechanically cooperates with the press plate. An adjustable retainer member extends from the first surface of the base and is adjustable such that a user can select a height of the adjustable retainer. The dispenser is held in place between the adjustable retainer member and the press plate. A pump or spray mechanism of the dispenser is in physical contact with the adjustable retainer member. A sensor is in electrical communication with the actuator. When the sensor detects an object in proximity to the sensor, the actuator is actuated to cause the press plate to move in a first direction. The press plate moving in the first direction causes the pump or spray mechanism of the dispenser to be depressed, which causes the substance within the container to be expelled or dispensed through the pump or spray mechanism.

The present disclosure is directed to various embodiments of a device that includes a base having a first surface and a second surface opposite to the first surface. A retainer member extending outward from the first surface. The retainer member includes an internal cavity, an aperture, and a cover that is moveable between an opened position and a closed position. In the opened position, the cover provides access to the internal cavity through the aperture such that a dispenser may be positioned within the internal cavity of the retainer member. In the closed position, the cover overlaps a portion of the aperture, in some instances, to hold the dispenser within the internal cavity of the retainer member. An actuator is aligned with the internal cavity and includes an end that contacts the dispenser. A sensor electrically communicates with the actuator such that when the sensor detects an object in proximity to the sensor, the actuator is actuated to cause the end to move in a first direction. The end moving in the first direction causes the pump or spray mechanism of the dispenser to be depressed, which causes the substance within the container of the dispenser to be expelled or dispensed.

### BRIEF DESCRIPTION OF THE SEVERAL VIEWS OF THE DRAWINGS

In the drawings, identical reference numbers identify similar elements or acts unless the context indicates otherwise. The sizes and relative proportions of the elements in the drawings are not necessarily drawn to scale.

FIG. 1A is a perspective view of a first embodiment of a touchless dispenser;

FIG. 1B is a front-plan view of the first embodiment of the touchless dispenser;

FIG. 1C is a right-plan view of the first embodiment of the touchless dispenser;

FIG. 1D is a left-plan view of the first embodiment of the touchless dispenser;

FIG. 1E is a rear-plan view of the first embodiment of the touchless dispenser;

FIG. 1F is a bottom-plan view of the first embodiment of the touchless dispenser;

FIG. 1G is a top-plan view of the first embodiment of the touchless dispenser;

FIG. 1H is a cross-sectional view of the first embodiment of the touchless dispenser taken along line A-A in FIG. 1G;

FIG. 1I is a perspective view of the first embodiment of the touchless dispenser and a dispenser on the first embodiment of the touchless dispenser;

FIG. 2A is a perspective view of a second embodiment of a touchless dispenser;

FIG. 2B is a front-plan view of the second embodiment of the touchless dispenser;

FIG. 2C is a right-plan view of the second embodiment of the touchless dispenser;

FIG. 2D is a left-plan view of the second embodiment of the touchless dispenser;

FIG. 2E is a rear-plan view of the second embodiment of the touchless dispenser;

FIG. 2F is a bottom-plan view of the second embodiment of the touchless dispenser;

FIG. 2G is a top-plan view of the second embodiment of the touchless dispenser;

FIG. 2H is a cross-sectional view of the second embodiment of the touchless dispenser taken along line B-B in FIG. 2G;

FIG. 2I is a cross-sectional view of the second embodiment of the touchless dispenser taken along line B-B in FIG. 2G and the touchless dispenser has a cover in an opened position;

FIG. 2J is a rear-plan perspective view of the second embodiment of the touchless dispenser and the touchless dispenser has the cover in the opened position;

FIG. 2K is a top plan view of the second embodiment of the touchless dispenser and the touchless dispenser has the cover in the opened position;

FIG. 2L is a cross-sectional view of the second embodiment of the touchless dispenser taken along line B-B in FIG. 2G with a dispenser in the second embodiment of the touchless dispenser with the cover in a closed position;

FIG. 2M is a cross-sectional view of the second embodiment of the touchless dispenser taken along line B-B in FIG. 2G with the dispenser in the second embodiment of the touchless dispenser with the cover in the opened position;

FIG. 2N is a top-plan view of the second embodiment of the touchless dispenser with the dispenser in the second embodiment of the touchless dispenser with the cover in the opened position; and

FIG. 3 is a perspective view of a third embodiment of a touchless dispenser.

### DETAILED DESCRIPTION

In the following description, certain specific details are set forth in order to provide a thorough understanding of various embodiments of the disclosure. However, one skilled in the art will understand that the disclosure may be practiced without these specific details. In other instances, well-known structures and components associated with dispensers such as pump dispensers, spray dispensers, squeeze dispensers, pour dispensers, etc. have not been described in detail to avoid unnecessarily obscuring the descriptions of the embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

The use of ordinals such as first, second, third, fourth, etc., does not necessarily imply a ranked sense of order, but rather may only distinguish between multiple instances of an act or structure.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms “left.” “right.” “top,” and “bottom.” are used for only discussion purposes based on the orientation of the components in the discussion of the Figures in the present disclosure as follows. These terms are not limiting as the possible positions explicitly disclosed, implicitly disclosed, or inherently disclosed in the present disclosure.

The term “substantially” is used to clarify that there may be slight differences or variations as for when a surface is coplanar with another surface in the real world, as nothing can be made perfectly equal or perfectly the same. In other words, substantially means that there may be some slight variation in actual practice and instead is made within accepted tolerances.

As used in this specification and the appended claims, the singular forms “a,” “an,” and “the” include plural referents unless the content clearly dictates otherwise.

Various embodiments of the present disclosure are directed to embodiments of a touchless dispenser.

In some embodiments, a touchless dispenser includes an adjustable retainer member extending outward from a first surface of a base, a press plate that is at the first surface of the base, an actuator mechanically cooperating with the press plate to move the press plate in a first direction and allow a press plate to move in a second direction opposite to the first direction, and a sensor electrically cooperating or in electrical communication with the actuator. Embodiments in accordance with the present disclosure are used with a dispenser including a dispense portion (e.g., a spray head, a pump, a mist head, or some other type of dispense mechanism) and a container in fluid communication with the dispense portion. The dispenser is positioned between the adjustable retainer member and the press plate. The container contains a substance. The dispense portion physically contacts the adjustable retainer member, the container contacts and is on the press plate, and the dispenser is held in place by the press plate and the adjustable retainer member. When the sensor detects an object in proximity to the sensor, the sensor sends a signal to a controller, and the controller sends a signal to the actuator to move the press plate in the first direction and causes the press plate to push against the container of the dispenser, and the dispense portion is depressed by the adjustable retainer member. As the dispense portion is depressed, the dispense portion expels a portion of the substance within the container of the dispenser. A dimension of the adjustable retainer member directed in the first direction is adjustable to preselect the dimension depending on a dimension of the dispenser. The adjustable retainer member allows for the touchless dispenser to be a universal touchless dispenser that can receive any number of various sized and shaped dispensers.

In some embodiments, a touchless dispenser includes a retainer member extending from a first surface of a base. The retainer member includes an internal cavity, an aperture, and a cover moveable between an opened position and a closed position. When the cover is in the opened position, the internal cavity is accessible through the aperture such that a dispenser is positioned within the internal cavity or removed from the internal cavity and replaced. When the cover is in the closed position, the cover may partially or fully overlap the aperture to hold or retain the dispenser within the internal cavity of the retainer member. The dispenser includes a dispense portion (e.g., a spray head, a pump, a mist head, or some other type of dispense mechanism) and a container in fluid communication with the dispense portion. The dispenser is positioned between an end of an actuator and a portion of the retainer member. The actuator is aligned with the internal cavity. A sensor is electrically cooperating or in electrical communication with the actuator. When the sensor detects an object in proximity to the sensor, the sensor sends a signal a controller, and the controller sends a signal to the actuator to move the end of the actuator into the internal cavity, causing the end to push against the container of the dispenser and causes the dispense portion to push against the portion of the retainer member depressing the dispense portion. As the dispense portion is depressed, the dispense portion expels a portion of the substance within the container of the dispenser. A spacer may be placed within the internal cavity of the retainer member depending on the size and shape of the dispenser to be positioned within the internal cavity of the retainer member. The spacer allows for the retainer member to be a universal touchless dispenser that can receive any number of various sized and shaped dispensers.

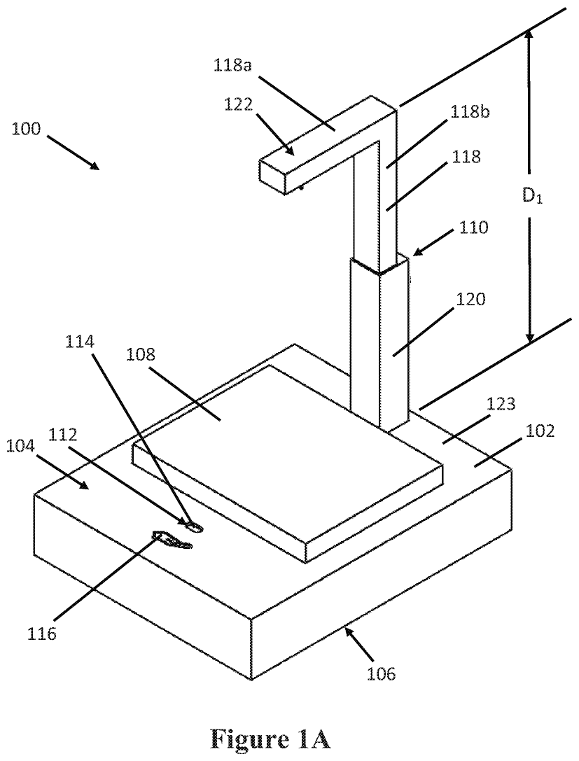

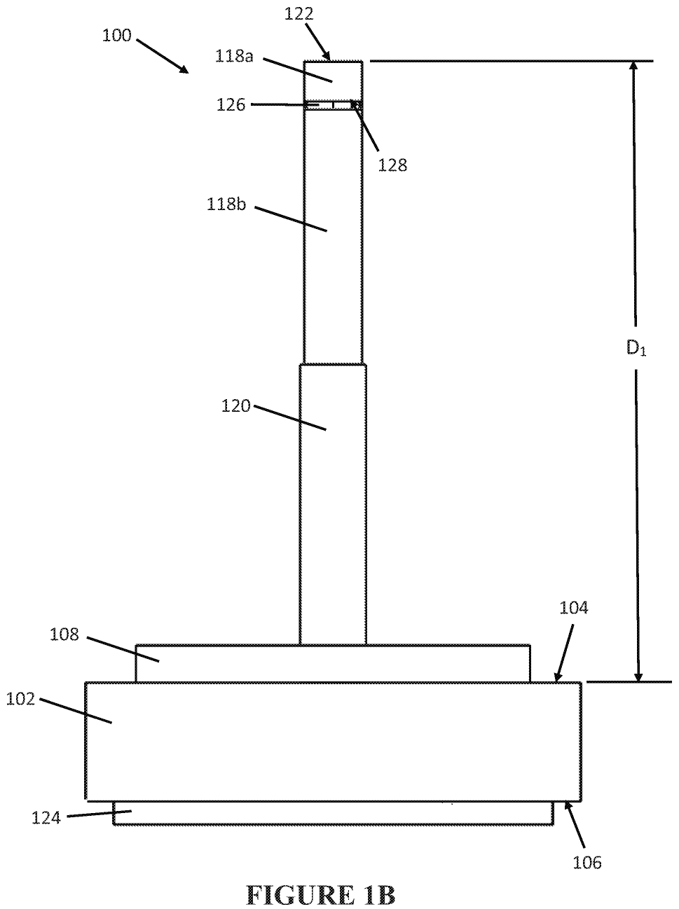

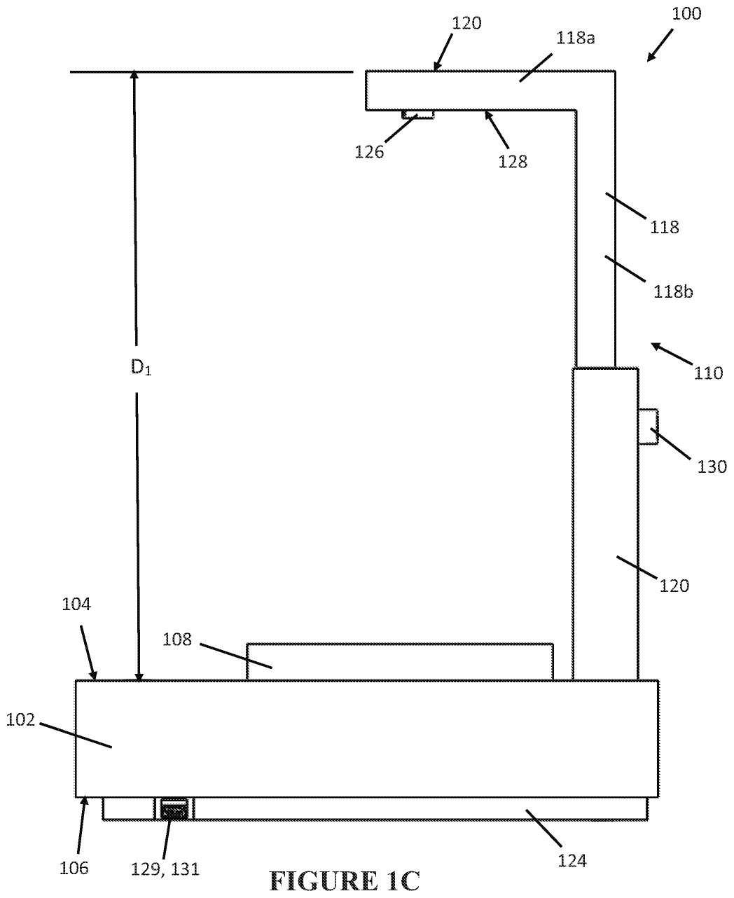

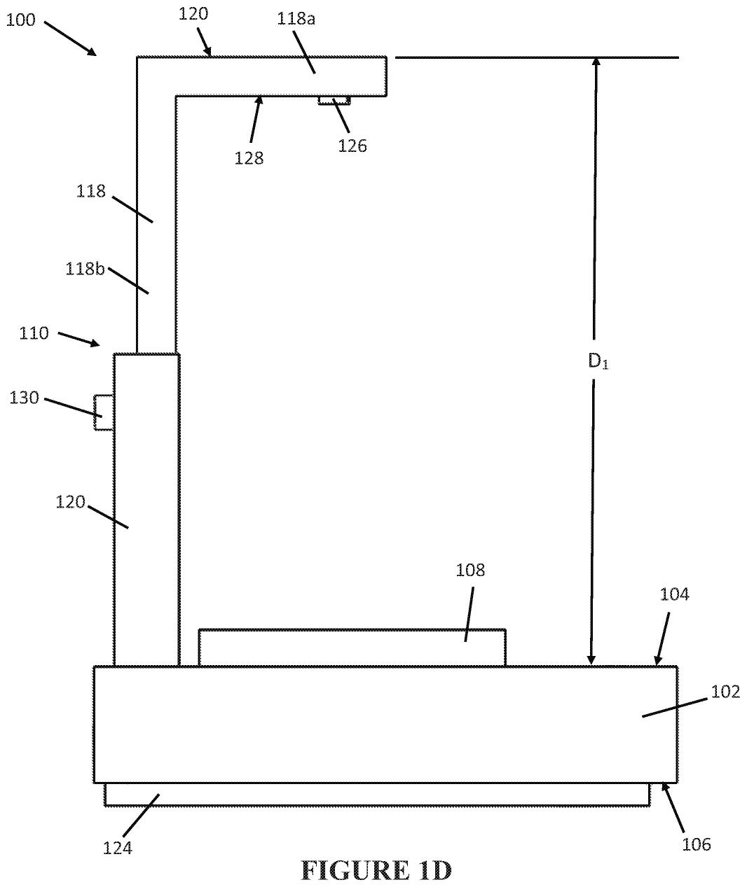

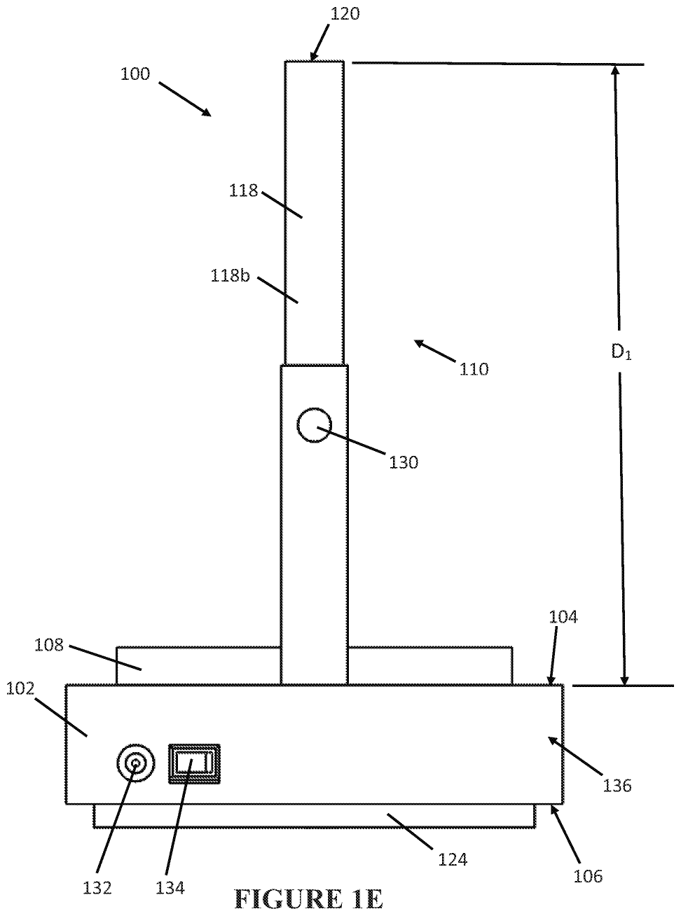

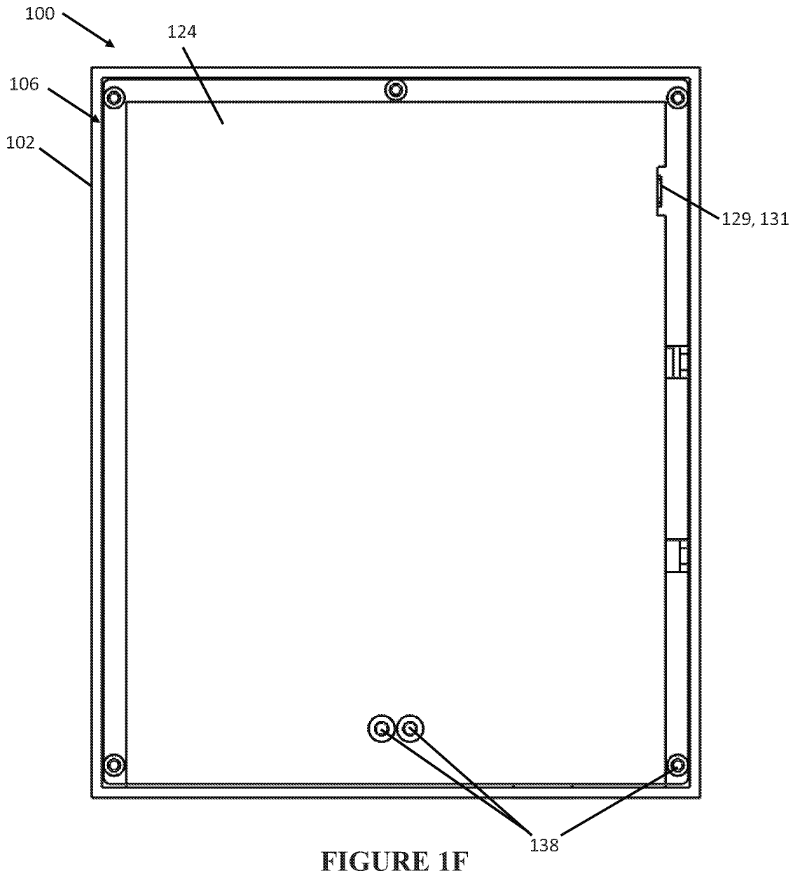

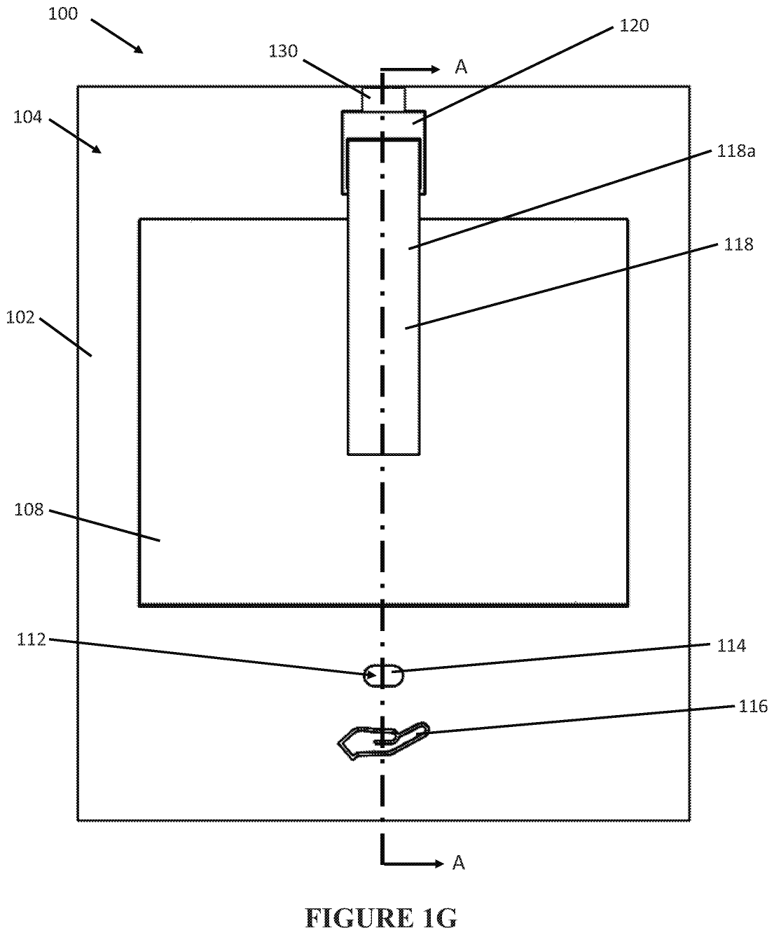

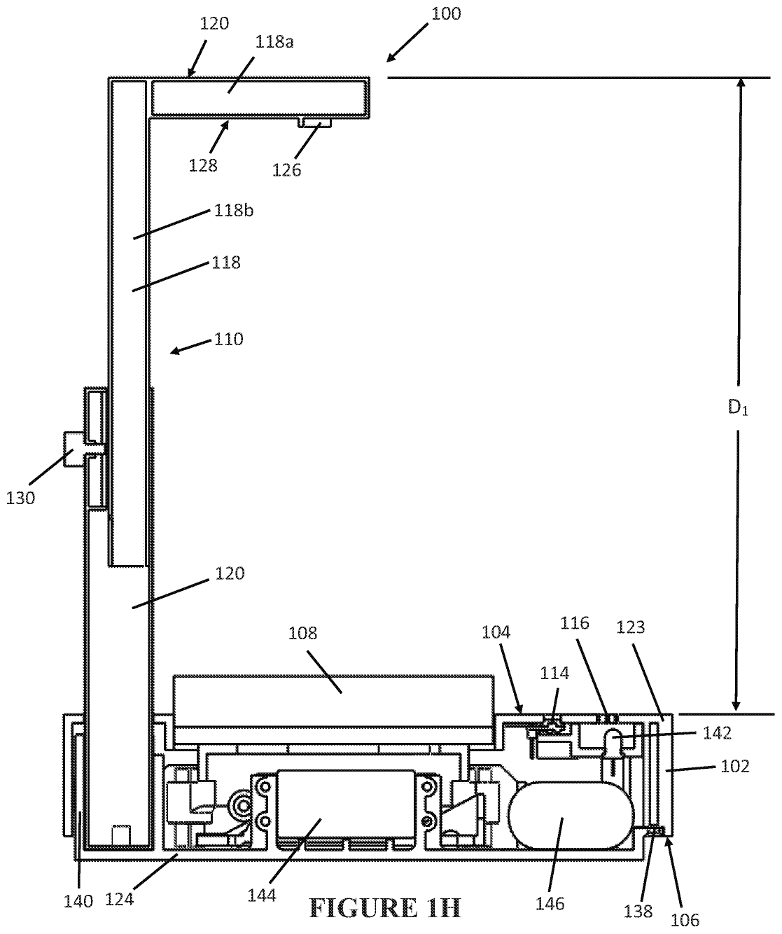

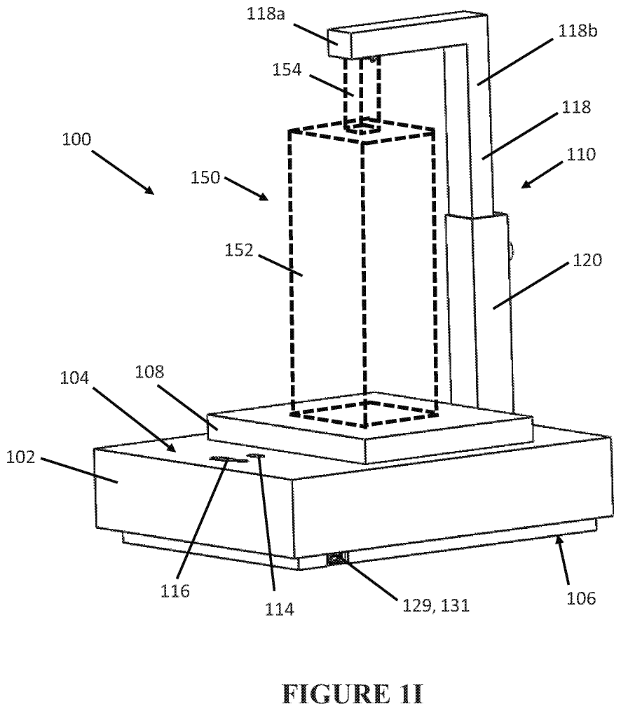

FIGS. 1A-1G are directed to various views of a first embodiment of a touchless dispenser 100.

FIG. 1A is a perspective view of the first embodiment of the touchless dispenser 100 including a base 102 having a first surface 104 and a second surface 106 opposite to the first surface 104, a press plate 108 at the first surface 104, and an adjustable retainer member 110 that extends away from and outward from the first surface 104 of the base 102. The base 102 includes a cover portion 123 and a surface contact portion 124, both of which can be seen in FIG. 1H.

The base 102 includes an opening 112 that extends into the first surface 104. A sensor 114 (e.g., a proximity sensor, a laser sensor, a motion sensor, a time-of-flight (TOF) sensor, or some other sensor configured to detect an object) is within the base 102 and is aligned with the opening 112. When a sensor 114 detects an object, the sensor 114 sends a signal to a controller 131, and the controller 131 sends a signal to an actuator 144, which is mechanically cooperating with the press plate 108. The actuator 144 can be seen in FIG. 1H. The movement of the actuator 144 in response to the detection of the object by the sensor will be discussed in greater detail later within the present disclosure with respect to FIG. 1I.

An indicator 116 is on the first surface 104 of the base 102. The indicator 116 may be lit up by a light emitting device 142 (e.g., a light emitting diode, an incandescent bulb, or some other light source) within the base 102, which can be seen in FIG. 1H. For example, the indicator 116 may be lit up in a red color when there is no object detected by the sensor 114, may be lit up in a green color when there is an object detected by the sensor 114, or may be lit up by any color as selected or programed to indicate whether an object is or is not detected by the sensor 114. In the first embodiment of the touchless dispenser 100, the indicator 116 depicts a hand of a user.

The adjustable retainer member 110 includes a first portion 118 and a second portion 120. The second portion 120 is hollow and receives the first portion 118. In this embodiment, the second portion is press fit into an opening in the base 102. In some embodiments, the second portion 120 may be an integral portion of the base 102 such that the second portion 120 is made of a continuous material with the base 102.

The second portion 120 receives the first portion 118, and the first portion 118 slides along and within the second portion 120 in a telescopic manner, which allows a user to select a first dimension D₁ of the adjustable retainer member 110 by adjusting an amount the first portion 118 is telescopically inserted into the second portion 120. The first dimension D₁ extends in a direction transverse to the first surface 104, and the first dimension D₁ extends from the first surface 104 to a surface 122 of the first portion 118. Telescopic or telescopically is defined as a first portion being received by a second portion, and the first portion slides in a first direction further into the second portion or slides further out of the second portion in a second direction opposite to the first direction. In other words, the movement and interaction of first portion 118 and the second portion 120 portions is similar to the operation of a telescope.

In this embodiment, the first portion 118 is substantially L-shaped. The first portion 118 includes a cantilever portion 118a and an insert portion 118b. The cantilever portion 118a is transverse to the insert portion 118b, and the cantilever portion 118a overhangs and overlaps the press plate 108. The insert portion 118b is inserted into the second portion 120, and the insert portion 118b slides along and within the second portion 120 telescopically in a first direction further into the second portion 120 or in a second direction further out of the second portion 120. The second direction is opposite to the first direction. The insert portion 118b may be locked in place once the first dimension D₁ is selected.

FIG. 1B is a front plan view of the first embodiment of the touchless dispenser 100.

The base 102 of the first embodiment of the touchless dispenser 100 includes the surface contact portion 124 at the second surface 106 of the base 102. The surface contact portion 124 comes into contact with a surface on which the first embodiment of the touchless dispenser is placed. The surface may be a table, a platform, a shelf, or some other surface that the first embodiment of the touchless dispenser 100 may be positioned, located, or placed. The surface contact portion 124 may include a non-slip material, may be made of a rubber material, or may include a plurality of rubber feet to avoid the first embodiment of the touchless dispenser 100 tipping over if bumped or from being pushed off a table when in use within a department store, a clothing store, a mall, or some other location by a user. The surface contact portion 124 may be referred to as a non-slip portion, a non-slide portion, a grip portion, a suction cup portion, a non-tip portion, or some other reference to a portion that reduces the likelihood of sliding, slipping, tipping, or falling of the first embodiment of the touchless dispenser 100.

In some embodiments, the surface contact portion 124 may be made of a material of other portions of the base 102.

A dispense contact portion 126 is on a surface 128 of the cantilever portion 118a of the first portion 118 of the adjustable retainer member 110. The surface 128 is opposite to the surface 122. The dispense contact portion 126 comes into contact with a dispense portion of a dispenser and holds the dispenser in a stationary position on the press plate 108. The dispense contact portion 126 may be made of a rubber material, a non-stick material, or some other relatively elastic or soft material that will not damage the dispense portion of the dispenser over the usable lifespan of the dispense portion. In some embodiments, the dispense contact portion 126 may be a plurality of rubber studs that contact the dispense portion to disperse a force applied to the dispensing mechanism in a uniform manner across a surface of the dispense portion of the dispenser to reduce the likelihood of damaging the dispense portion of the dispenser.

FIG. 1C is a right-plan view of the first embodiment of the touchless dispenser 100. FIG. 1D is a left-plan view of the first embodiment of the touchless dispenser 100.

The first embodiment of the touchless dispenser 100 includes an input/output (I/O) port 129 of the controller 131 at the surface contact portion 124. The I/O port 129 is a port of the controller 131 within the base 102. The controller 131 may be an Arduino, a Raspberry Pi, or some other type of controller or micro-controller configured to control electrical components within the first embodiment of the touchless dispenser 100. The I/O port 129 provides access to the controller 131 such that an operator can update software on the controller 131, select and define parameters (e.g., speed of movement of the press plate, delay time for actuation of the press plate, force applied by the press plate, amount of time the press plate is moved, or other control parameters) for controlling the first embodiment of the touchless dispenser 100, conduct a diagnostic review of electrical components within the first embodiment of the touchless dispenser, or some other type of control operation or review of the first embodiment of the touchless dispenser.

In some embodiments, the I/O port 129 may be positioned in a different location on the first embodiment of the touchless dispenser. For example, the I/O port 129 may be positioned at a rear surface 136, at the first surface 104, at the second surface 106, or at some other surface of the first embodiment of the touchless dispenser that is accessible by a user or operator.

The first embodiment of the touchless dispenser 100 includes a lock portion 130 on the second portion 120 of the adjustable retainer member 110. The lock portion 130 may be referred to as a lock mechanism, a compression lock mechanism, a pin and hole lock mechanism, or some other type of lock portion that locks the first portion 118 of the adjustable retainer member 110 in a stationary, fixed, or locked position. For example, the lock portion 130 may be loosened by a counter-clockwise rotation and tightened by a clockwise rotation. When the lock portion 130 is loosened by the counter-clockwise rotation, the insert portion 118b of the first portion 118 can slidably moves along the second portion 120 and slidably moves either into or out of the second portion 120. Once the first portion 118 is in a position to select the dimension D₁, the lock portion 130 is tightened by the clockwise rotation and a portion of the lock portion physically contacts and locks the first portion 118 in a stationary, fixed, or locked position. The dimension D₁ may be selected based on a dimension of a dispenser that is positioned on and utilized by the first embodiment of the touchless dispenser 100.

FIG. 1E is directed to a rear-plan view of the first embodiment of the touchless dispenser 100.

The first embodiment of the touchless dispenser 100 includes a port 132 and a switch 134 on a surface 136 of the first embodiment of the touchless dispenser 100. The surface 136 is transverse to the first surface 104 and the second surface 106 of the base 102.

In this embodiment, the input port 132 is an input for a cable to recharge a power source 146 within the base 102. The input port 132 may be referred to as a recharge port 132 that is in electrical communication with a power source 146 within the base 102. The power source 146 can be seen in FIG. 1H. The recharge port 132 is configured to receive a recharge cable to recharge the power source 146 within the base 102. The power source 146 may be a rechargeable battery, a rechargeable battery pack, or some other power source that is rechargeable.

In some embodiment, the input port 132 is a power port 132 that is in electrical communication with electronic components within the base 102. The power port 132 receives a power cable that supplies power to electronic components within the base 102. For example, the power port 132 provides power through electrical lines, electrical wires, or some other electrical connection electrically coupled between the power port 132 and the electronic components within the first embodiment of the touchless dispenser 100.

In this embodiment, the switch 134 is an on/off switch 134 in electrical communication with electronic components within the base 102 or within the first embodiment of the touchless dispenser 100. The on/off switch 134 has an on position and an off position. When the on/off switch 134 is in the on position, the first embodiment of the touchless dispenser 100 is powered up. When the on/off switch 134 is in the off position, the first embodiment of the touchless dispenser 100 is powered off or down.

In some embodiments, the switch may have a lower power operation mode, a high power operation mode, or some other controls in addition to on and off. For example, the switch 134 may be a rotary switch or knob that allows a user to select any number of operational modes as well as turn on and off the first embodiment of the touchless dispenser 100.

FIG. 1F is a bottom-plan view of the first embodiment of the touchless dispenser 100.

The first embodiment of the touchless dispenser 100 includes a plurality of fasteners 138 that couple or attach the surface contact portion 124 to the cover portion 123 of the first embodiment of the touchless dispenser 100. For example, the plurality of fasteners 138 may be a threaded bolts, screws, nuts, snap-fit fasteners, or some other type of fasteners.

In some embodiments, the surface contact portion 124 may be coupled to the cover portion 123 by an adhesive, a combination of an adhesive and a plurality of fasteners, or by some other attachment or fastening technique or features.

In some embodiments, the surface contact portion 124 may be hingedly coupled or temporarily coupled through a snap-fit to the cover portion 123 of the first embodiment of the touchless dispenser such that the surface contact portion 124 can be removed from the cover portion 123 or opened to access components internal within the base 102 of the first embodiment of the touchless dispenser 100.

FIG. 1G is a top-plan view of the first embodiment of the touchless dispenser 100. A line A-A extends along an axis of the cantilever portion 118a of the first portion of the adjustable retainer member 110.

FIG. 1H is a cross-sectional view of the first embodiment of the touchless dispenser 100 taken along line A-A in FIG. 1G. As can be seen in FIG. 1H, the base 102 of the first embodiment of the touchless dispenser 100 is hollow and contains several electronic components internally between the cover portion 123 and the surface contact portion 124.

The surface contact portion 124 includes a reception portion 140 that receives the second portion 120 of the adjustable retainer member 110. The reception portion 140 holds the second portion 120 stationary relative to the base 102. The reception portion 140 may form an interference fit that is tight and snug to hold the adjustable retainer member 110 stationary. However, the interference fit may be loose enough such that the adjustable retainer member 110 is replaceable by a user or an operator if the adjustable retainer member fails or breaks.

In some embodiments, some of the plurality of fasteners 138 may extend through the surface contact portion 124 into the adjustable retainer member 110 to couple the adjustable retainer member 110 to the base 102.

The sensor 114 is within the base 102. The sensor 114 may be covered by a transparent cover that is within the opening 112 to protect the sensor 114 from external debris, dust, or other external objects that may damage the sensor 114. For the sake of brevity and simplicity of the present disclosure, the earlier discussion with respect to the functionality of the sensor 114 has not been reproduced here.

The light emitting device 142 is within the base 102. The light emitting device 142 is aligned with the indicator 116. In this embodiment, the light emitting device 142 is a light emitting diode (LED). For the sake of brevity and simplicity of the present disclosure, the earlier discussion of the functionality of the light emitting device 142 has not been reproduced here.

The actuator 144 is within the base 102 and is mechanically cooperating with the press plate 108. The actuator 144 may be a piston actuator, an electric motor actuator, a linear actuator, an extension actuator, or some other actuator that is configured to move the press plate 108 in a first direction and allow movement of the press plate 108 in a second direction opposite to the first direction. As discussed earlier, the actuator 144 moves the press plate 108 and this movement of the press plate 108 will be discussed in greater detail within the present disclosure with respect to FIG. 1L.

The power source 146 is within the base and is in electrical communication with other components within the base 102. In this embodiment, the power source 146 is in electrical communication with sensor 114, the light emitting device 142, the actuator 144, and the controller 131. The power source 146 may be coupled to the sensor 114, the light emitting device 142, the actuator 144, and the controller 131 by a plurality of electrical connections within the base 102. These electrical connections may be electrical lines, electrical wires, or some other electrical connection within the base 102. When the first embodiment of the touchless dispenser 100 is turned on, the power source 146 sends, communicates, and provides electrical power to the light emitting device 142, the actuator 144, and the controller 131. For the sake of brevity and simplicity of the present disclosure, the earlier discussion of the power source 146 has not been reproduced here.

The controller 131 is within the base 102. However, the controller 131 cannot be seen in FIG. 1H as the controller is behind the power source 146, and a portion of the controller 131 is between an internal surface of the base 102 and the power source 146. For the sake of brevity and simplicity of the present disclosure, the earlier discussion of the controller 131 has not been reproduced here.

FIG. 1L is a perspective view of the first embodiment of the touchless dispenser 100. FIG. 1L shows a dispenser or product container 150 in broken lines that is positioned between the cantilever portion 118a and the press plate 108 of first embodiment of the touchless dispenser 100.

The dispenser 150 includes a container 152 and a dispense portion 154 (e.g., a spray mechanism, a pump mechanism, a mist mechanism, or some other dispense mechanism). The container 152 of the dispenser 150 is on the press plate 108 and the bottom of the container 152 physically contacts the press plate 108. The top of the dispense portion 154 of the dispenser 150 is on and is in physical contact with the dispense contact portion 126 on the cantilever portion 118a. The container 152 of the dispenser contains a substance (e.g., (e.g., perfume, cologne, soap, sanitizer, etc.) and the dispense portion 154 dispenses the substance. For example, the dispense portion 154 dispenses the substance through a spray nozzle, a mist nozzle, or a pump mechanism when the dispense portion is depressed.

The dispenser 150 is sandwiched between the dispense contact portion 126 and the press plate 108 such that the dispenser 150 is held in a stationary position relative to the dispense contact portion 126 and the press plate 108. The dimension D₁ of the adjustable retainer member 110 is selected utilizing the lock portion 130 as discussed earlier within the present disclosure. For the sake of brevity and simplicity of the present disclosure, the adjustable selection of the dimension D₁ of the adjustable retainer member 110 is not reproduce here.

In use, the first embodiment of the touchless dispenser 100 functions as follows. When a user positions an object (e.g., a hand of the user, a test swab, a test paper, a test strip, or some other object) above or in front of the sensor 114, the sensor 114 detects the object and sends a signal to the controller 131, which interprets and reviews the signal from the sensor 114 to determine if an object is present.

If the controller 131 determines that an object is present, the controller 131 sends a signal to the actuator 144, and, in response to the signal from the controller 131, the actuator 144 pushes on the press plate 108 or actuates the press plate in a first direction, which is transverse to the first surface 104 of the base 102. In an embodiment, the signal sent by the controller 131 to move the actuator 144 is delayed by a selected period of time such that after the object is identified and determined to be present, the movement of the actuator 144 is delayed to reduce the likelihood of the object not being aligned with the dispense portion 154 when the dispense portion 154 dispenses the substance within the container 152 of the dispenser 150. The selected delay time may be selected or set by a user, an operator, or an employee programming or setting parameters for the first embodiment of the touchless dispenser 100.

As the press plate 108 moves in the first direction, the container 152 of the dispenser is moved in the first direction as well, and the container pushes against the dispense portion 154 of the dispenser 150. The dispense portion 154 is pushed against the dispense contact portion 126 on the cantilever portion 118a. The cantilever portion 118a is in a fixed position and is held in place by the lock portion 130 even when pushed against by the dispense portion 154 of the dispenser. As the dispense portion 154 is pushed against the dispense contact portion 126, the dispense portion 154 is depressed and the substance within the container 152 is expelled or dispensed from the dispense portion 154 (e.g., a spray nozzle, a mist nozzle, a pump, etc.).

After the substance is dispensed through the dispense portion 154, the actuator 144 allows for the press plate 108 to move in a second direction opposite to the first direction. In other words, the press plate 108 is retracted in the second direction. The movement of the press plate 108 in the second direction results in the dispense portion 154 becoming undepressed and re-extended to a non-depressed or extended state. This functionality of the first embodiment of the touchless dispenser 100 provides the user or customer access the substance within the container 152 of the dispenser 150 through the dispense portion 154 of the dispenser 150 without having to touch the dispenser 150 or the first embodiment of the touchless dispenser 100.

In some embodiments, the sensor 114 may send the signal directly to the actuator 144, which then actuates the press plate 108 as discussed earlier within the present disclosure.

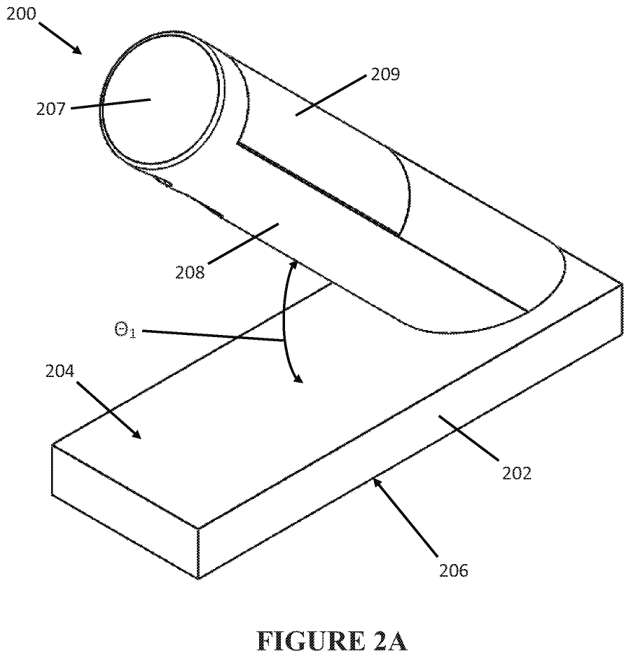

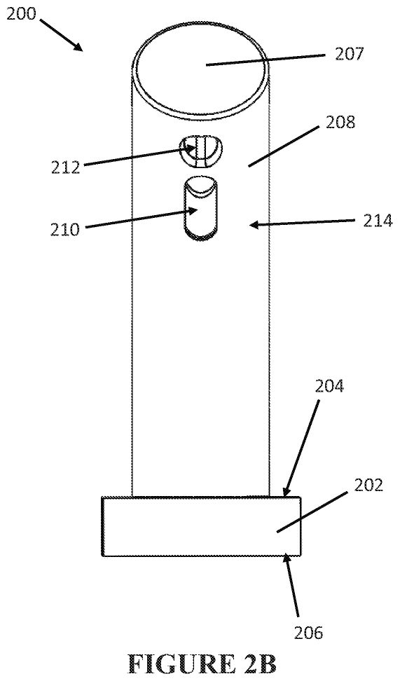

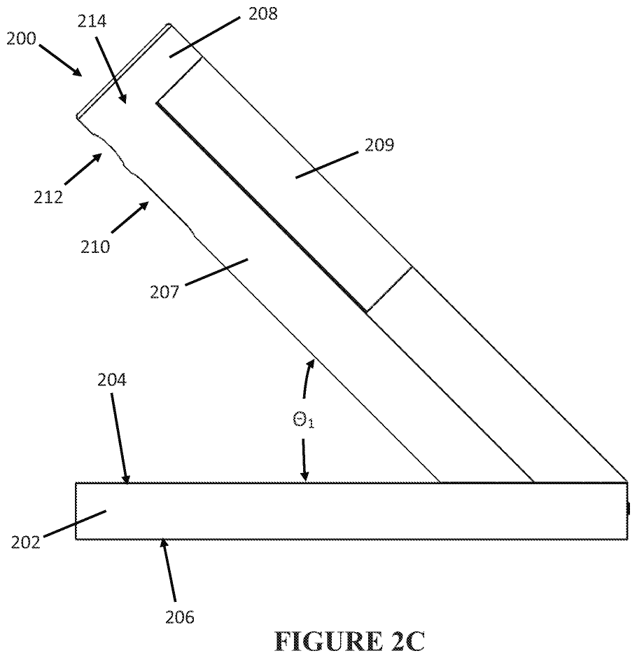

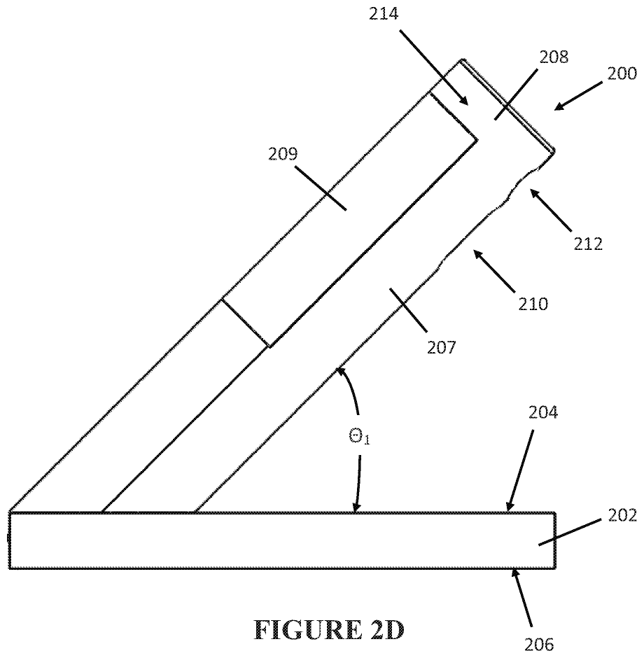

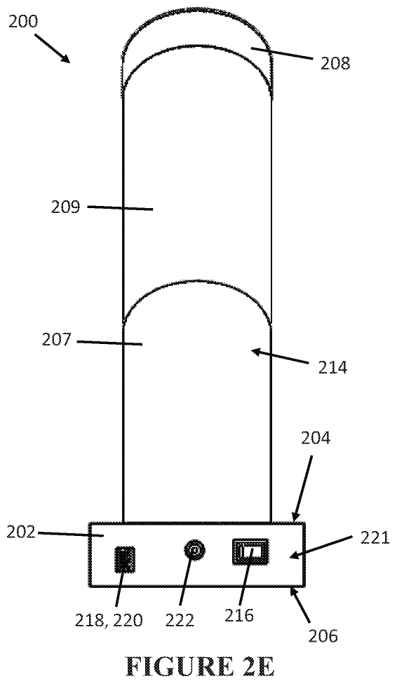

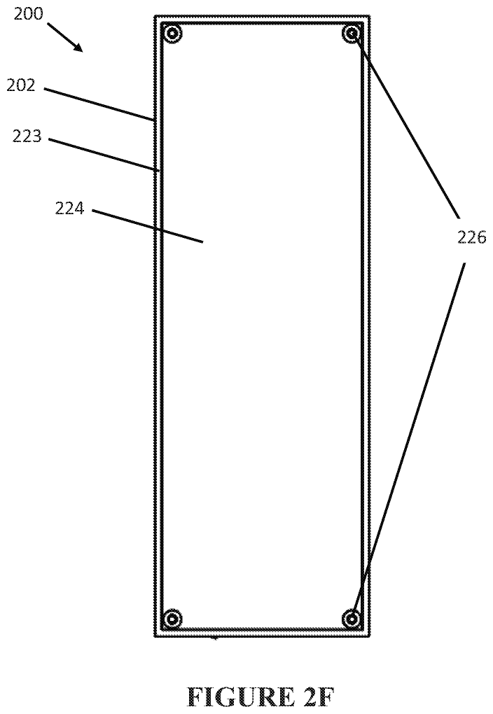

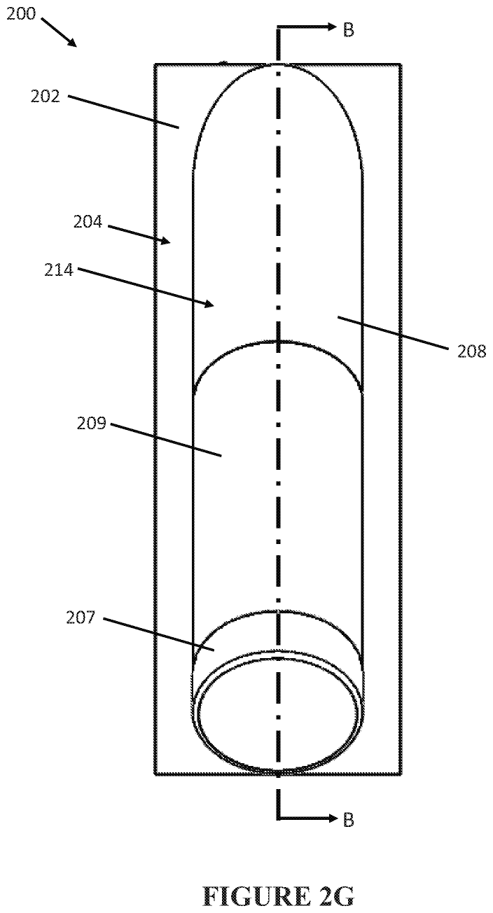

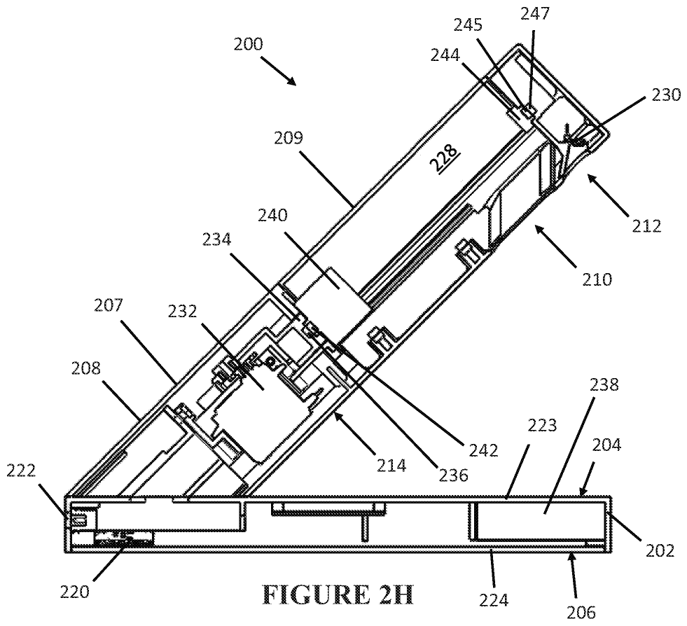

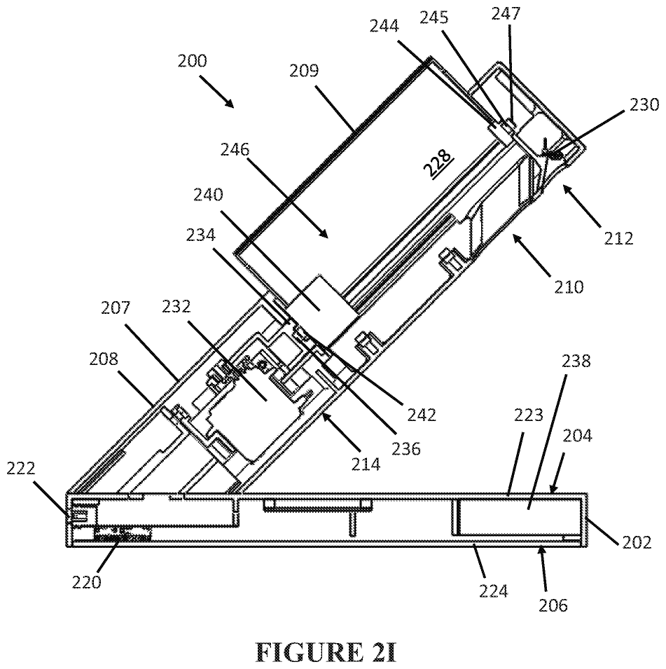

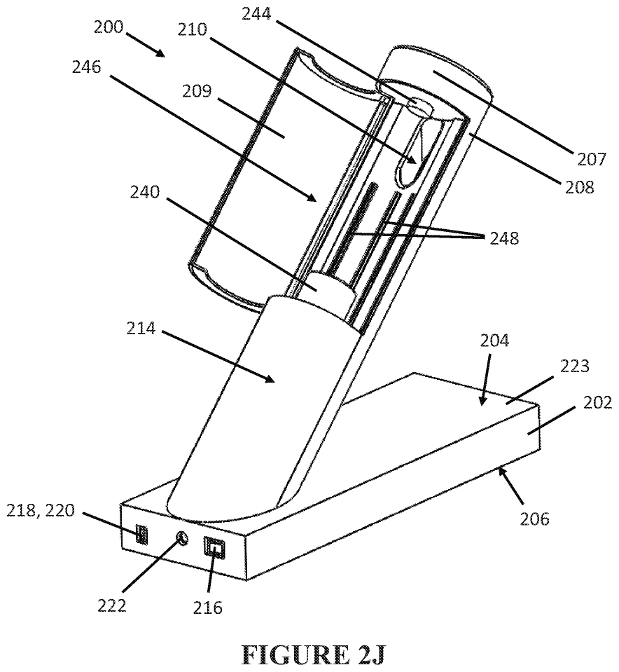

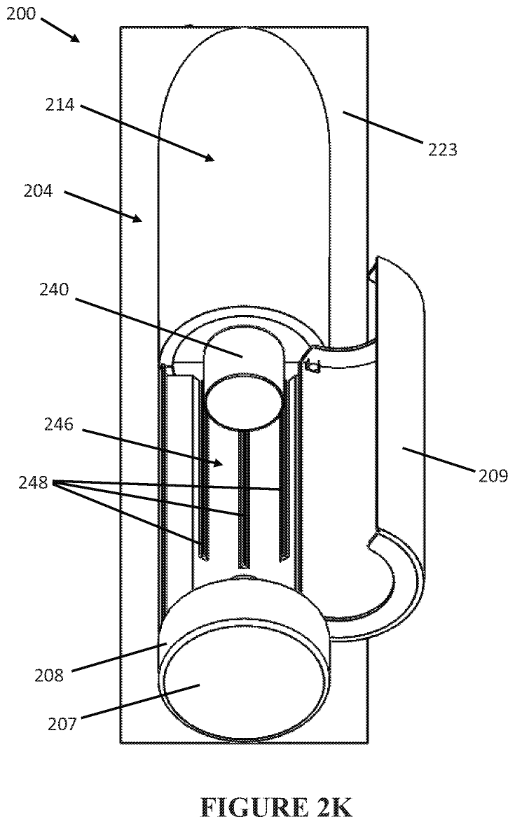

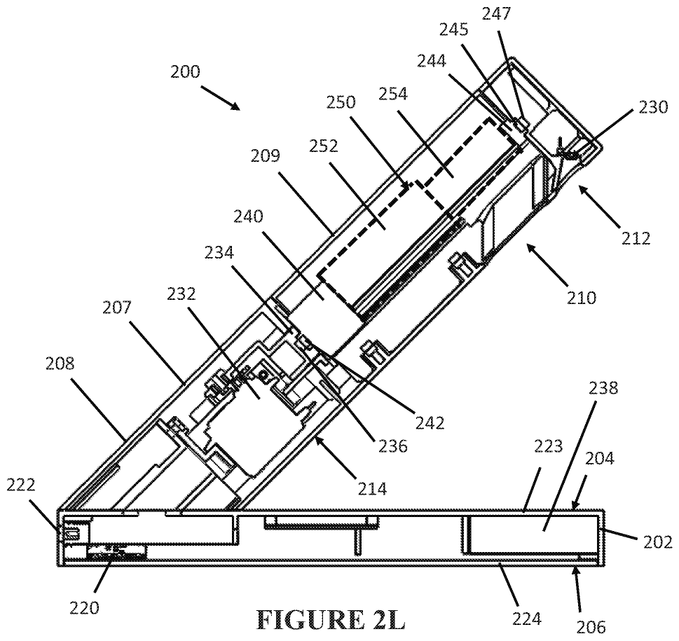

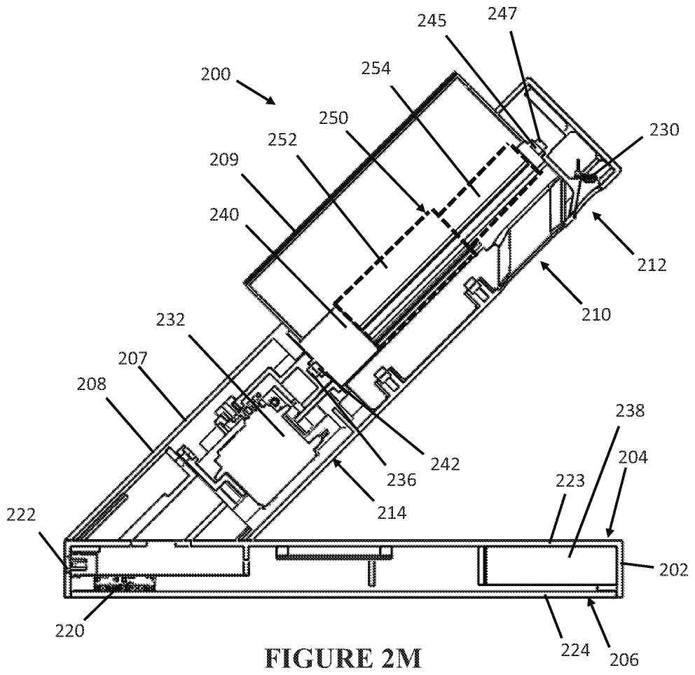

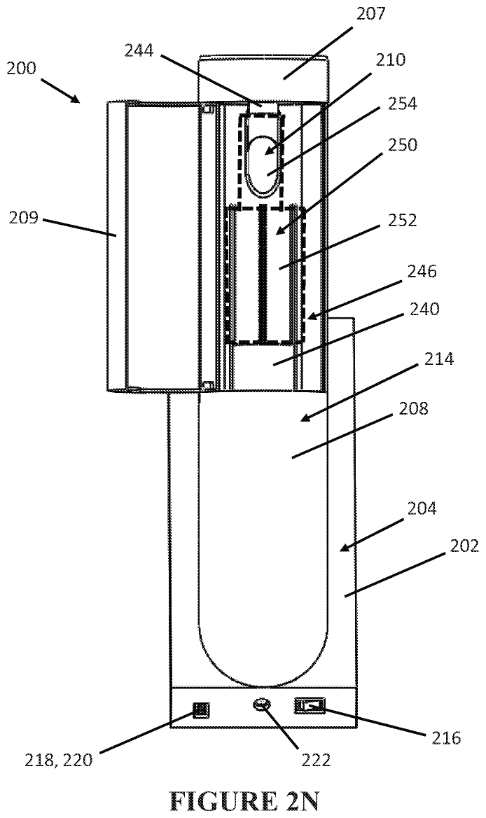

FIGS. 2A-2G are directed to various views of a second embodiment of a touchless dispenser 200.

FIG. 2A is a perspective view of the second embodiment of the touchless dispenser 200 including a base 202 that includes a first surface 204 and a second surface 206 opposite to the first surface 204.

A retainer member 207 extends away from and outward from the first surface 204 of the base 202. A body 208 of the retainer member 207 extends away from the base 202 in a direction that is transverse to the first surface 204. The body 208 is transverse to the first surface 204 by an angle θ₁, which may be an angle that is less than 90-degrees or is substantially equal to 90-degrees (e.g., perpendicular to the first surface 204 of the base 202). The body 208 may be integral the base 202 and may be made of a continuous material with the base 202.

In some embodiments, the angle θ₁ may be an obtuse angle relative to the first surface 204 of the base 202.

In some embodiments, the body 208 of the retainer member 207 may be coupled to the base 202 by a fastener (e.g., threaded bolt, screws, nuts, snap-fit fasteners, etc.), a snap fit mechanism, or some other temporary coupling technique such that the retainer member 207 may be replaceable or interchangeable.

The retainer member 207 includes a cover 209 that overlaps or covers an aperture 246 in the body 208 of the retainer member 207 to provide access to an internal cavity 228 within the body 208 of the retainer member 207. The cover 209 entirely or completely overlaps the aperture 246 closing the internal cavity 228 from an external environment. The cover 209 is hingedgly coupled to the body 208 of the retainer member 207. The cover 209 has an opened position and a closed position. In the opened position, the cover 209 provides access to the internal cavity 228 through the aperture 246. In the closed position, the cover 210 closes the internal cavity 228 off from the external environment through the aperture 246.

In some embodiments, the cover 209 may partially overlap and cover the aperture 246 such that a portion of the aperture remains uncovered and the internal cavity is still exposed to the external environment.

FIG. 2B is directed to a front-plan view of the second embodiment of the touchless dispenser 200.

The body 208 of the retainer member 207 includes a dispense opening 210 and a sensor opening 212 that both extend into an outer surface 214 of the body 208 of the retainer member 207. The dispense opening 210 extends into the outer surface 214 to the internal cavity 228 within the body 208 of the retainer member 207 exposing the internal cavity 228 to the external environment. The internal cavity 228 can be seen in FIG. 2H.

A sensor 230 is within the body 208 of the retainer member 207 and is aligned with the sensor opening 212 to expose the sensor 230 to the external environment. The sensor can be seen in FIG. 2H. The sensor 230 is the same or similar to the sensor 114 as discussed with respect to the first embodiment of the touchless dispenser 100. For the sake of brevity and simplicity of the present disclosure, the discussion of the sensor 114 with respect to the first embodiment of the touchless dispenser 100 applies to the sensor 230 in the second embodiment of the touchless dispenser 200, and, therefore, the discussion of the sensor 114 is not reproduced here.

FIG. 2C is a right-plan view of the second embodiment of the touchless dispenser 200. FIG. 2D is a left-plan view of the second embodiment of the touchless dispenser 200.

FIG. 2E is a rear-plan view of the second embodiment of the touchless dispenser 200.

Referring to FIG. 2E, the second embodiment of the touchless dispenser 200 includes a switch 216, an input/output (I/O) port 218 of a controller 220, and an input port 222 on a rear surface 221 of the base 202. The input port 222 may be referred to as a power port 222 or a recharge port 222. The switch 216 is similar or the same as the switch 134 as discussed with respect to the first embodiment of the touchless dispenser 100. The I/O port 218 and the controller 220 are similar or the same as the I/O port 129 and the controller 131, respectively, as discussed with respect to the first embodiment of the touchless dispenser 100. The input port 218 is the same or similar to the input port 132 as discussed with respect to the first embodiment of the touchless dispenser 100. For the sake of brevity and simplicity of the present disclosure, the discussions of the switch 134, the I/O port 129, and the input port 132 with respect to the first embodiment of the touchless dispenser 100 apply to the switch 216, the I/O port 218, the controller 220, and the input port 222, respectively, of the second embodiment of the touchless dispenser 200, and, therefore, the discussion of the switch 134, the I/O port 129, and the input port 132, respectively, are not reproduced here.

FIG. 2F is a bottom-plan view of the second embodiment of the touchless dispenser 200.

Referring to FIG. 2F, the base 202 includes a cover portion 223 and a surface contact portion 224. The cover portion 223 and the surface contact portion 224 of the base 202 of the second embodiment of the touchless dispenser 200 are the same or similar as the cover portion 123 and the surface contact portion 124, respectively, as discussed with respect to the first embodiment of the touchless dispenser 100. For the sake of brevity and simplicity of the present disclosure, the discussions of the cover portion 123 and the surface contact portion 124 with respect to the first embodiment of the touchless dispenser 100 apply to the cover portion 223 and the surface contact portion 224 of the second embodiment of the touchless dispenser 200, respectively, and, therefore, the discussion of the cover portion 123 and the surface contact portion 124, respectively, are not reproduced here.

A plurality of fasteners 226 couple the surface contact portion 224 to the cover portion 223. The plurality of fasteners 226 are the same or similar to the plurality of fasteners 138 as discussed with respect to the first embodiment of the touchless dispenser 100. For the sake of brevity and simplicity of the present disclosure, the discussion of the plurality of fasteners 138 with respect to the first embodiment of the touchless dispenser 100 applies to the plurality of fasteners 226 of the second embodiment of the touchless dispenser 200, and, therefore, the discussion of the plurality of fasteners 138 are not reproduced here.

FIG. 2G is a top-plan view of the second embodiment of the touchless dispenser 200. A line B-B extends along an axis of the retainer member 207.

FIG. 2H is a cross-sectional view of the second embodiment of the touchless dispenser 200 that is taken along line B-B in FIG. 2G.

Referring to FIG. 2H, the sensor 230 is within the retainer member 207 and is aligned with the sensor opening 212. The sensor 230 is exposed to the external environment outside the retainer member 207 through the sensor opening 212 such that the sensor 230 can detect an object outside the retainer member 207. The sensor 230 is in electrical communication with the controller 220 within the base 202 of the second embodiment of the touchless dispenser 200.

In some embodiments, the sensor opening 212 may be covered by a translucent material, a transparent material, or some other material that stops debris from entering the sensor opening 212 and damaging the sensor 230.

An actuator 232 is within the retainer member 207 and is enclosed within the retainer member 207. The actuator 232 is the same or similar to the actuator 144 of the first embodiment of the touchless dispenser 100. For the sake of brevity and simplicity of the present disclosure, the discussion of the functionality of the actuator 144 of the first embodiment of the touchless dispenser 100 applies to the functionality of the actuator 232 of the second embodiment of the touchless dispenser, and, therefore, the discussion of the actuator 144 is not reproduced here.

However, unlike the actuator 144 of the first embodiment of the touchless dispenser 100, the actuator 232 of the second embodiment of the touchless dispenser 200 has an end 234 that extends into the internal cavity 228 in a first direction and out of the internal cavity 228 in a second direction. The end 234 extends into the internal cavity through an opening at a first end of the internal cavity 228. The first direction is directed away from the actuator 232 towards the internal cavity 228, and the second direction is directed away from the internal cavity 228 towards the actuator 232. The end 234 includes a recess that extends into the end 234 of the actuator, and a first magnet 236 is positioned at the recess of the end 234 of the actuator 232.

A power source 238 is within the base 202 of the second embodiment of the touchless dispenser 200 and is in electrical communication with the input port 222. The power source 238 may be in electrical communication with the input port 222 through at least one electrical line, electrical wire, or some other electrical connection. The power source 238 is in electrical communication with at least the controller 220, the input port 222, the sensor 230, and the actuator 232. The power source 238 supplies power to at least the controller 220, the input port 222, the sensor 230, and the actuator 232 when the switch 216 is in the on position. The power source 238 does not supply power to at least the controller 220, the input port 222, the sensor 230, and the actuator 232 when the switch is in the off position. The power source 238 is the same or similar to the power source 146 as discussed with respect to the first embodiment of the touchless dispenser 100. For the sake of simplicity and brevity of the present disclosure, the discussion of the power source 146 with respect to the first embodiment of the touchless dispenser 100 applies to the power source 238 of the second embodiment of the touchless sensor 200.

In the embodiment illustrated in FIG. 2H, a spacer 240 is on (e.g., in contact with or attached to) the end 234 of the actuator 232. The spacer 240 includes a second magnet 242 that is magnetically attracted to the first magnet 236. The second magnet 242 is at an end of the spacer 240 that is positioned adjacent to the end 234 of the actuator 232 and is received by the recess in the end 234 of the actuator 232. The attraction between the first magnet 236 and the second magnet 242 is strong enough to hold the end of the spacer 240 within the recess at the end 234 of the actuator 232. However, the attraction between the first magnet 236 and the second magnet 242 is weak enough such that a user or an operator may remove the spacer 240 from the recess by simply pulling on the spacer 240. The spacer 240 is positioned at the first end of the internal cavity 228.

The spacer 240 is removable from the internal cavity and may be interchangeable with several other spacers of differing sizes (e.g., differing lengths, widths, diameters, dimensions, etc.) and shapes (e.g., round, oval, polygonal, etc.) that a user can select from depending on a shape or size of a dispenser that is to be positioned within the internal cavity 228 of the retainer member 207. For example, if a smaller dispenser (i.e., shorter in length) is to be positioned within the internal cavity 228, a larger spacer (i.e., longer in length) may be positioned within the internal cavity 228 to hold the smaller dispenser stationary within the internal cavity 228. Alternatively, if a larger dispenser (i.e., longer in length) is to be positioned within the internal cavity 228, a smaller spacer (i.e., shorter in length) or no spacer may be positioned within the internal cavity 228 to hold the larger dispenser stationary within the internal cavity 228. The size, e.g., length of the spacer is such that when used in combination with a dispenser 250, the bottom of the dispenser 250 rests on the top of the spacer 240 and the top of the dispense portion 254 contacts the dispense contact portion 244 or is close enough in proximity to the dispense contact portion 244 that actuation of the actuator 232 causes the dispense portion 254 to be depressed sufficiently to dispense material from the container 252 through the dispense portion 254.

In some embodiments, the spacer 240 may be removably mounted within the internal cavity 228 utilizing a snap-fit, an interference fit, or some other temporary fit or temporary mounting technique.

In this second embodiment of the touchless dispenser 200, an end of the internal cavity 228 opposite the end that receives the spacer 240 includes a dispense contact portion 244. The dispense contact portion 244 may be made of a rubber, an elastomer, or some other elastic material. The dispense contact portion 244 includes a third magnet 245 at an end of the dispense contact portion 244 furthest from spacer 240. The third magnet 245 is coupled to a fourth magnet 247 located in an end of the retainer member 207 adjacent the dispense contact portion 244. The third magnet 245 and the fourth magnet 247 interact in the same or similar fashion as the first magnet 236 and the second magnet 242. The dispense contact portion 244 is the same or similar to the dispense contact portion 126 discussed with respect to the first embodiment of the touchless dispenser 100. For at the sake of brevity and simplicity of the present disclosure, the discussion of the dispense contact portion 126 with respect to the first embodiment of the touchless dispenser 100 applies to the dispense contact portion 244 of the second embodiment of the touchless dispenser 200, and, therefore, the discussion of the dispense contact portion 126 is not reproduced here. Similar to how the spacer 240 is interchangeable or removable from the internal cavity 228, the dispense contact portion 244 may also be interchanged or removed from the internal cavity 228 depending on the size and shape of a dispenser to be positioned within the internal cavity 228. The dispense contact portion 244 may be referred to as a spacer, a spacer contact portion, a spacer dispense contact portion, or some other terminology for a portion that contacts a dispense portion of a dispenser.

In this second embodiment of the touchless dispenser 200, the spacer 240 is larger in size and shape (e.g., volume and height) relative to the dispense contact portion 244.

In some embodiments, the dispense contact portion 244 may be mounted within the internal cavity 228 in a removable or temporary manner utilizing a snap-fit, an interference fit, or some other temporary fit or temporary mounting technique.

FIG. 2I is a cross-sectional view of the second embodiment of the touchless dispenser 200 taken along line B-B in FIG. 2G when the cover 209 is in an opened position. FIG. 2J is a rear-plan perspective view of the second embodiment of the touchless dispenser 200 when the cover 209 is in the opened position. FIG. 2K is a top-plan view of the second embodiment of the touchless dispenser 200 when the cover 209 is in the opened position. The cover 209 is in an opened position providing access to the internal cavity 228 of the retainer member 207 through the aperture 246. A plurality of bumper portions 248 are positioned on an internal surface that partially defines the internal cavity 228 of the retainer member 207 when the cover 209 is in the closed position as shown in FIGS. 2A-2H. The plurality of bumper portions 248 may be made of a rubber, an elastomer, or some other elastic material.

FIG. 2L is a cross-sectional view of the second embodiment of the touchless dispenser 200 with a product dispenser 250 received within internal cavity 228. The dispenser 250 includes a container 252 that contains a substance and a dispense portion 254 that expels or dispenses the substance from the container when the dispense portion is depressed. The container 252 contacts and is supported by the bumper portions 248. The dispenser 250, the container 252, and the dispense portion 254 are the same or similar to the dispenser 150, the container 152, and the dispense portion 154, respectively, as discussed with respect to the first embodiment of the touchless dispenser 100. For the sake of brevity and simplicity of the present disclosure, the discussions of the dispenser 150, the container 152, and the dispense portion 154 with respect to the first embodiment of the touchless dispenser 100 applies to the dispenser 250, the container 252, and the dispense portion 254, respectively, and, therefore, the discussion of the dispenser 150, the container 152, and the dispense portion 154 is not reproduced here.

The dispenser 250 is positioned within the internal cavity 228 of the retainer member 207. The bottom end of the container 252 of the dispenser 250 is in physical contact with the spacer 240 and the top end of the dispense portion 254 of the dispenser 250 is in physical contact with the dispense contact portion 244. The spacer 240 and the dispense contact portion 244 sandwich the dispenser 250 there between and hold the dispenser 250 stationary within the internal cavity 228 relative to the spacer 240 and the dispense contact portion 244.

In use the second embodiment of the touchless dispenser 200 functions as follows. When a user positions an object (e.g., a hand of the user, a test swab, a test paper, a test strip, or some other object) above or in front of the sensor 230, the sensor 114 detects the object and sends a signal to the controller 220, which interprets and reviews the signal from the sensor 230 to determine if an object is present.

If the controller 220 determines that the object is present, the controller 220 sends signal to the actuator 232, and, in response to the signal from the controller 220, the actuator 232 extends the end 234 of the actuator outward into the internal cavity 228. As the end 234 extends into the internal cavity 228, the end 234 pushes against the spacer 240, and the spacer 240 pushes against the bottom of container 252 of the dispenser 250. The signal sent by the controller 220 to move the end 234 of the actuator 232 is delayed by a selected period of time such that after the object is identified and determined to be present, this delays the movement of the actuator 232 to reduce the likelihood of the object not being aligned with the dispense portion 254 when the dispense portion 254 dispenses the substance within the container 252 of the dispenser 250. The selected delay time may be selected or set by a user, an operator, or an employee programming or setting parameters for the first embodiment of the touchless dispenser 100.

As the container 252 is pushed and moves in the first direction towards the dispense contact portion 244 by the first end 234 of the actuator 232, the dispense portion 254 is pushed against the dispense contact portion 244 and the dispense portion 254 is depressed. The dispense contact portion 244 is held in a stationary position within the internal cavity 228 and the top of the dispense portion 254 pushes against the dispense contact portion 244, causing the dispense portion 254 to be depressed. The depression of the dispense portion 254 results in the substance in the container being dispensed or expelled through the dispense portion 254 and out of the dispense opening 210 of the retainer member 207. The dispensing of the substance from the retainer member allows a user to obtain a sample of the substance in the container 252 without having to touch the retainer member 207 or the dispenser 250.

After the substance is dispensed through the dispense opening 210, the actuator 232 allows the end 234 to move in the second direction opposite to the first direction. In other words, the end 234 is retracted in the second direction. The movement of the end 234 in the second direction results in the dispense portion 254 becoming undepressed and re-extended to a non-depressed or extended state. The functionality of the second embodiment of the touchless dispenser 200 allows for the user to access the substance within the container 252 of the dispenser 250 through the dispense portion 254 of the dispenser 250 without having the touch the dispenser 250 or the second embodiment of the touchless dispenser 200.

In some embodiments, the sensor 230 may send the signal directly to the actuator 232, which then actuates the end 234 as discussed earlier within the present disclosure.

FIG. 2M is a cross-sectional view of the second embodiment of the touchless dispenser 200 taken along line B-B in FIG. 2G. FIG. 2N is a top-plan perspective view of the second embodiment of the touchless dispenser 200. The cover 209 is in the opened position. When the cover 209 is in the opened position, the dispenser 250 may be interchanged with another dispenser of a different shape or size, the spacer 240 may be interchanged with another spacer of a different shape or size depending on the shape and size of the another dispenser, and the dispenser contact portion 244 may be interchanged to another dispenser contact portion 244 of a different shape or size depending on the shape and size of the another dispenser. For example, if the dispenser is a relatively large dispenser, e.g., having a length that extends from the bottom to the top of the internal cavity 228 of the retainer member, the spacer 240 and the dispense contact portion 244 may both be removed from the internal cavity. Alternatively, if the dispenser is a relatively small dispenser, e.g., does not have a length that extends fully from the bottom to the top of the internal cavity 228, the spacer 240 may be replaced with a larger spacer and the dispense contact portion 244 may be replaced with a larger dispenser contact portion. Alternatively, if the dispenser is relatively intermediate in size, e.g., of a length intermediate a length of a large dispenser and a small dispenser, the spacer 240 and the dispense contact portions 244 may be of an intermediate size. In other words, the spacer 240 and the dispense contact portion 244 may be interchanged with any number of differing sized and shaped spacers and dispense contact portion to adjust for the size and shape of the dispenser to be positioned within the internal cavity 228 of the retainer member 207.

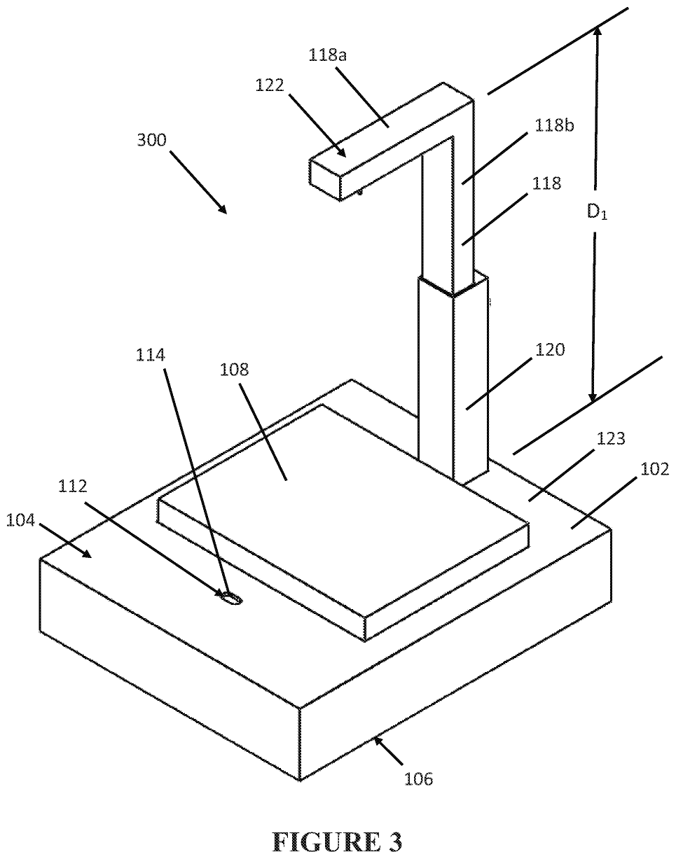

FIG. 3 is directed to a third embodiment of a touchless dispenser 300 that does not include the indicator 116. Otherwise, the third embodiment of the touchless dispenser 300 has the same or similar features as the first embodiment of the touchless dispenser 100. For the sake of brevity and simplicity of the present disclosure, the discussion with the same or similar features of the first embodiment of the touchless dispenser 100 is not reproduced here. The same or similar features of the third embodiment of the touchless dispenser 300 have the same or similar reference numerals as those same or similar features in the second embodiment of the touchless dispenser 100.

The first and second embodiment of the touchless dispenser 100, 200 as discussed above are adapted to be adjustable to be universally receive any number of dispenser that are utilized within various industries (e.g., cleaning industry, beauty industry, cosmetic industry, sanitizing industry, etc.). For example, the first and second embodiments of the touchless dispenser 100, 200 are able to be adjusted to receive a dispenser with a first height, a second dispenser with a second height that is greater than the first height, or a third dispenser with a third height that is between the first height and the second height. Similarly, the first and second embodiments of the touchless dispenser 100, 200 may receive a dispenser that is cylindrical in shape, a dispenser that is rectangular (e.g., rectangular frustum) in shape, trapezoidal (e.g., trapezoidal frustum) in shape, or some other three-dimensional shape dispenser.

The ability of the first and second embodiments of the touchless dispenser 100, 200 to universally accept, receive, and utilize any number of dispensers allows for a user or an operator to easily switch out or interchange a product that is within the touchless dispensers 100, 200. For example, if the touchless dispenser 100, 200 contains a test sample and the test sample is running low, an operator or user can quickly and easily replace the test sample with a new test sample. Alternatively, if the user or operator would like to place a different product in a different shape dispenser than the original test sample, the user or operator can quickly and easily switch them. The ability to interchange various dispensers containing various different substances allows for large amounts of flexibility in the substances the touchless dispensers may dispense. The touchless dispensers 100, 200 ability to universally accept, receive, and utilize any number of dispensers reduces costs as only a single touchless dispenser design is needed to provide tests samples to customers of various substances that are packaged in containers of many different types, sizes, and shapes, instead of having to have multiple specialized touchless dispensers only capable of utilizing specific shaped dispensers.

The ability of the first and second embodiments of the touchless dispenser 100, 200 to universally accept, receive, and utilize any number of dispensers of various shape and size also provides a hygienic experience to a customer utilizing the touchless dispensers 100, 200 to obtain some of the substance as a test sample. A customer utilizing the touchless dispensers 100, 200 is provided a highly hygienic experience as the customer does not need to touch or contact the dispenser of the test sample, which was previously touched by a user, an operator, or an employee when positioning the dispenser of the test sample in the touchless dispenser. In other words, the customer utilizing the touchless dispenser to obtain some of the test sample does not need to physically touch the dispenser of the test sample or physically touch the touchless dispenser to obtain some of the test sample within the dispenser. As the customer does not touch or contact the dispenser of the test sample previously touched or contact by the user, operator, or employee when placing the dispenser of the test sample in the touchless dispenser, the spread of pathogens such as bacteria, viruses (e.g., flu, common cold, etc.), diseases, illnesses, etc., is reduced. For example, if the touchless dispenser is utilized in a department store, hundreds or thousands of customers may utilize the touchless dispenser to obtain some of the test sample in the dispenser, which means that none of these hundreds or thousands of customers need to touch the same surface as the user, operator, or employee or the other customers that utilize the touchless dispenser to obtain some of the test sample.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device, comprising:
a base having a first surface and a second surface opposite to the first surface;
a press plate at the first surface of the base;
an adjustable retainer member extending outward from the first surface of the base, the adjustable retainer member having a first portion transverse to the first surface and a second portion transverse to the first portion, the adjustable retainer member configured to be adjustable to select a first dimension of the retainer member in a first direction transverse to the first surface;
an actuator that mechanically cooperates with the press plate, the actuator configured to cause the press plate to move in the first direction and to allow the press plate to move in a second direction opposite to the first direction, the second direction being transverse to the first surface; and
a sensor that electrically cooperates with the actuator, the sensor configured to detect an object.

2. A device, comprising:
a base having a first surface and a second surface opposite to the first surface;
a retainer member extending outward from the first surface, the retainer member being transverse to the first surface, the retainer member including:
an internal cavity;
an aperture; and
a cover moveable between an opened position and a closed position, the cover overlapping a portion of the aperture when in the closed position;
an actuator aligned with the internal cavity, the actuator including an end, the actuator configured to move the end in a first direction and move the end in a second direction opposite to the first direction; and
a sensor that electrically cooperates with the actuator, the sensor configured to detect an object.
